(19) United States
(12) Patent Application Publication
(10) Pub. No.: US 2010/0154446 A1
(43) Pub. Date: Jun. 24, 2010

(54) Refrigerator and controlling method thereof

(75) Inventors: Jae Hyuk Oh, Seongnam-si (KR); Seong Je Wu, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/591,948

(22) Filed: Dec. 4, 2009

(30) Foreign Application Priority Data
Dec. 22, 2008 (KR) 10-2008-131501

(51) Int. Cl. F25B 49/00; F25B 39/02; F25B 15/00; F25D 17/04; G05B 15/00

(52) U.S. Cl. 62/129; 62/176.1; 62/515; 62/231; 62/271; 62/404; 700/275

(57) ABSTRACT

Disclosed herein are a refrigerator capable of preventing frost from forming on an evaporator by mounting a dehumidifying unit and a recycling unit on both sides of the evaporator, respectively, and a controlling method thereof. Cold air in a storage chamber is dehumidified as the air passes through the dehumidifying unit and is sent to the evaporator. The cold air thermally exchanged in the evaporator is humidified as the air passes through the recycling unit and is sent to the storage chamber.

### CROSS-REFERENCE TO RELATED APPLICATIONS

This application claims the benefit of Korean Patent Application No. 2008-0131501, filed on Dec. 22, 2008 in the Korean Intellectual Property Office, the disclosure of which is incorporated herein by reference.

### BACKGROUND

1. Field

The present invention relates to a refrigerator and a controlling method thereof, and more particularly, to a refrigerator capable of preventing frosting at an evaporator, and a controlling method thereof.

2. Description of the Related Art

Generally, a refrigerator includes a storage chamber to store food therein, an evaporator to generate cold air, and a ventilation fan to send the cold air into the storage chamber.

The cold air is sent to the evaporator after circulating in the storage chamber. The cold air introduced into the evaporator flows along a surface of the evaporator. During this process, moisture in air forms frost on the surface of the evaporator, and as the frost increases, performance of the evaporator is deteriorated.

In a conventional refrigerator, to remove the frost layer accumulated on the evaporator, a cooling operation is suspended and a defrosting operation is performed. Generally, the defrosting operation is performed by generating heat by a defrosting heater mounted around the evaporator, melting the frost attached to the evaporator using the heat, and draining water generated by defrosting.

However, when the defrosting heater is operated, the inner temperature of the refrigerator is increased. Therefore, the cooling operation is necessitated and accordingly power consumption is increased. To this end, it is required to reduce the power consumption and also reduce the defrosting operation.

### SUMMARY

Therefore, it is an aspect of the present invention to provide a refrigerator capable of reducing power consumption caused by a defrosting operation, by preventing frosting at an evaporator, and a controlling method thereof.

Additional aspects and/or advantages of the invention will be set forth in part in the description which follows and, in part, will be apparent from the description, or may be learned by practice of the invention.

The foregoing and/or other aspects of the present invention are achieved by providing a refrigerator including a storage chamber to contain cold air; an evaporator mounted on a circulation path of the cold air; and a dehumidifying unit and a recycling unit removably mounted on first and second sides of the circulation path, the evaporator being disposed between the dehumidifying unit and the recycling unit.

The refrigerator may further include a humidity sensor sensing a humidity of the cold air as the cold air passes through the dehumidifying unit; and a control unit determining a time to replace the dehumidifying unit according to the sensed humidity.

The refrigerator may further include a control unit determining a time to replace the dehumidifying unit according to an accumulated operation time of the refrigerator, the operation time being accumulated in the timer.

The refrigerator may further include a display unit displaying a replacement time of the dehumidifying unit.

The foregoing and/or other aspects of the present inventions are also achieved by providing a refrigerator including a storage chamber to contain cold air; an evaporator mounted on a circulation path of the cold air; a dehumidifying unit and a recycling unit removably mounted on first and second sides of the circulation path, the evaporator being disposed between the dehumidifying unit and the recycling unit; a function conversion device exchanging functions of the dehumidifying unit and the recycling unit; and a control unit replacing the dehumidifying unit using the function conversion device when the dehumidifying unit is in a saturated state.

The refrigerator may further include a humidity sensor sensing a humidity of the cold air circulating in the storage chamber or the circulation path.

The refrigerator may further include a timer accumulating the operation time of the refrigerator.

The control unit may determine the saturated state of the dehumidifying unit according to one of the sensed humidity or the accumulated operation time.

The refrigerator may further include a plurality of dampers mounted at one side of the dehumidifying unit and the recycling unit, respectively, to selectively pass the cold air of the storage chamber.

The function conversion device may include a path conversion unit varying a path interconnecting the dehumidifying unit and the recycling unit.

The path conversion unit may vary between a main path connecting the dehumidifying unit and the recycling unit; a bypass path bypassing the main path; and a plurality of dampers to form any one of the main path and the bypass path.

The function conversion device may include a rotation unit to exchange positions of the dehumidifying unit and the recycling unit.

The rotation unit may include a dehumidifying unit; a rotational bar connected with the recycling unit at both sides thereof; a gear motor rotating the rotational bar; a circular gear connected with the gear motor; a rotational gear integrally formed with the rotational bar; and a rack meshed with the circular gear and the rotational gear.

The refrigerator may further include a gas supply pipe provided around the dehumidifying unit or the recycling unit to supply hot gas; and a valve mounted to the gas supply pipe to control supply of the hot gas.

The refrigerator may further include a receiving chamber receiving the evaporator; and a moisture outlet formed at the receiving chamber in fluid communication with external air, and a damper selectively opening and closing the moisture outlet.

The foregoing and/or other aspects of the present invention are achieved by providing a controlling method of a refrigerator including performing a cooling operation including passing cold air in a storage chamber through a dehumidifying unit and a recycling unit which are mounted on a connecting path; determining a saturated state of the dehumidifying unit during the cooling operation; and displaying a time to replace the dehumidifying unit when the dehumidifying unit is determined to be in the saturated state.

The saturated state of the dehumidifying unit may include determining according to humidity of the cold air passed through the dehumidifying unit.

The saturated state of the dehumidifying unit may include determining according to an accumulated operation time of the refrigerator.

The foregoing and/or other aspects of the present invention may also be achieved by providing a controlling method of a refrigerator, including performing a cooling operation including passing cold air in a storage chamber through a dehumidifying unit and a recycling unit which are mounted on a connecting path; determining a humidity in the storage chamber during the cooling operation; and passing the cold air selectively through the dehumidifying unit or the recycling unit according to the determined humidity in the storage chamber.

When the humidity in the storage chamber is greater than a predetermined reference humidity, the method may further include passing the cold air of the storage chamber only through the dehumidifying unit.

When the humidity in the storage chamber is greater than the reference humidity and the dehumidifying unit is in a saturated state, the method may further include passing the cold air past the dehumidifying and the recycling unit.

When the humidity in the storage chamber is not greater than the reference humidity and the dehumidifying unit is in a saturated state the method further include exchanging the functions of the dehumidifying unit and the recycling unit.

The saturated state of the dehumidifying unit may further include determining the saturated state of the dehumidifying unit according to the humidity of the cold air of the storage chamber, passing through the dehumidifying unit.

The saturated state of the dehumidifying unit may further include determining the saturated state of the dehumidifying unit according to an accumulated operation time of the refrigerator.

As described above, since the refrigerator according to embodiments of the present invention is capable of preventing frosting at an evaporator, a defrosting operation can be avoided or delayed. Accordingly, power consumption can be reduced.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a sectional view of a refrigerator according to an embodiment of the present invention;

FIG. 1B is a control block diagram of the refrigerator of FIG. 1A;

FIG. 1C is a flowchart illustrating a controlling method of the refrigerator;

FIG. 1D is a flowchart illustrating a modified version of a replacement time displaying operation in FIG. 1C;

FIG. 2A is a sectional view of a refrigerator according to another embodiment of the present invention;

FIG. 2B is a control block diagram of the refrigerator of FIG. 2A;

FIG. 3A is a perspective view of a path conversion unit for the refrigerator shown in FIG. 2A according to the another embodiment of the present invention;

FIG. 3B is a sectional view of the path conversion unit of FIG. 3A, cut along line z-z;

FIG. 3C is a view illustrating the operation of the path conversion unit of FIG. 3A using a main duct;

FIG. 3D is a view illustrating the operation of the path conversion unit of FIG. 3A using a bypass duct;

FIG. 4A is a perspective view of a modified version of a path conversion unit for the refrigerator of FIG. 2A;

FIG. 4B is a view illustrating the operation of the path conversion unit of FIG. 4A using a main duct;

FIG. 4C is a view illustrating the operation of the path conversion unit of FIG. 4A using a bypass duct;

FIG. 5A is a sectional view of a refrigerator according to still another embodiment of the present invention;

FIG. 5B is a perspective view of a rotation unit for the refrigerator of FIG. 5A;

FIG. 5C is a control block diagram of the refrigerator of FIG. 5A;

FIG. 5D is a sectional view of a refrigerator having a modified rotation unit, according to still another embodiment of the present invention;

FIG. 6 is a view showing a gas supply pipe and an opening and closing valve to recycle waste heat of the refrigerator;

FIG. 7 is a flowchart illustrating a controlling method of the refrigerator according to another embodiment of the present invention; and

FIG. 8 is a flowchart illustrating a modified version of a replacement time displaying operation in FIG. 7.

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

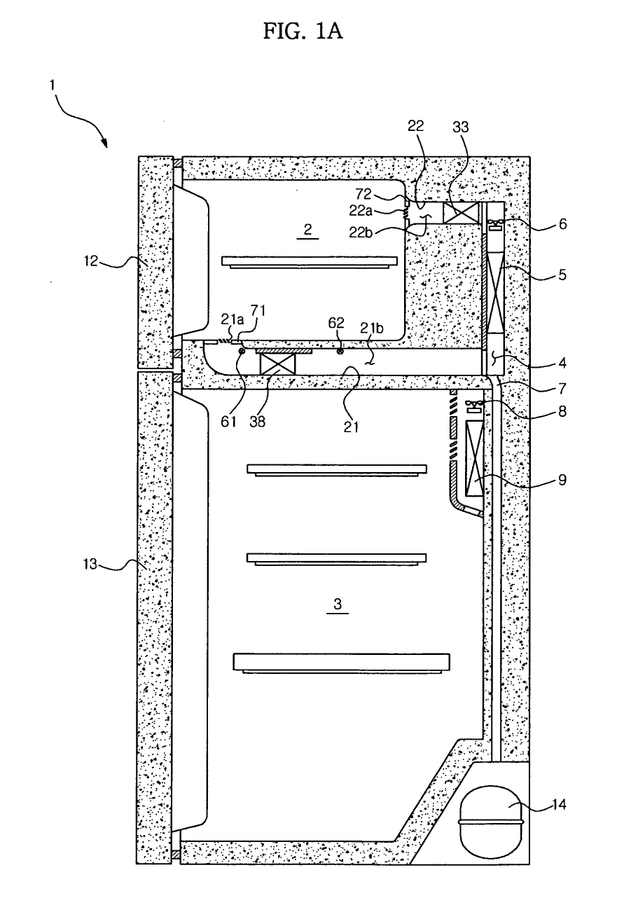

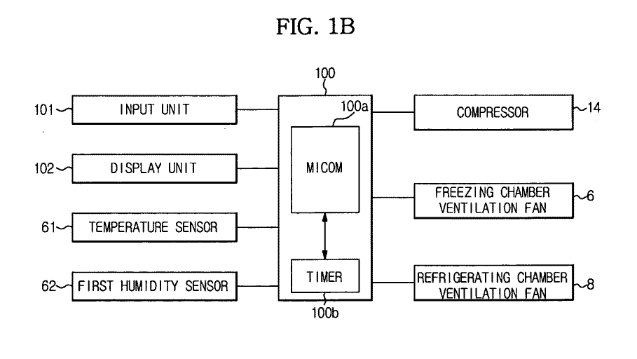

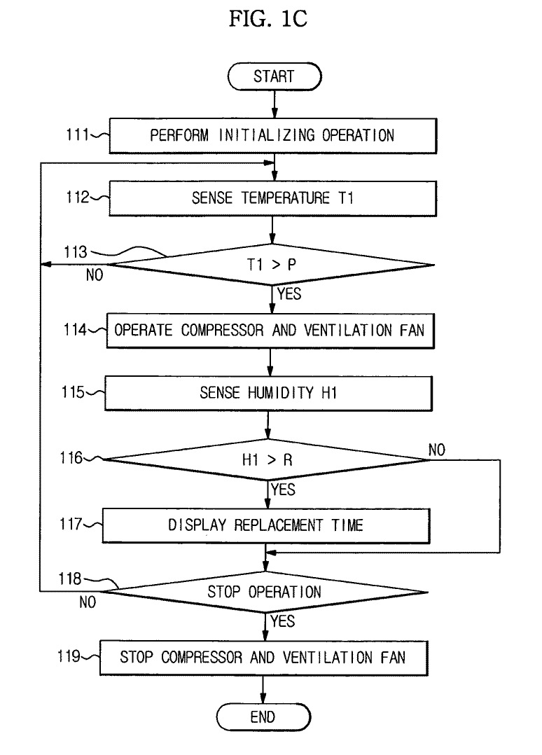

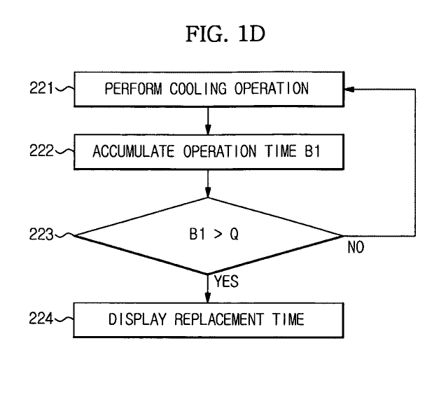

As shown in FIG. 1A, a refrigerator 1 according to an embodiment of the present invention includes storage chambers 2 and 3 (freezing and refrigerating) storing food therein, and doors 12 and 13 opening and closing front sides of the storage chambers 2 and 3, respectively.

An evaporator 5 and a ventilation fan 6 for the freezing chamber 2 are received in a receiving chamber 4 disposed at a rear part of the freezing chamber 2. An evaporator 9 and a ventilation fan 8 for the refrigerating chamber 3 are received in a rear part of the refrigerating chamber 3.

The freezing chamber 2 and the receiving chamber 4 are interconnected through first and second air ducts 21 and 22. The first and second air ducts 21 and 22 supply first and second paths 21b and 22b, respectively.

A dehumidifying unit 38 is removably mounted to the first path 21b and charged with a moisture absorbent that dehumidifies by absorbing moisture. A recycling unit 33 is removably mounted to the second path 22b and charged with a humidifying agent that regenerates and supplies moisture.

A user opens covers 71 and 72 and inserts the dehumidifying unit 38 and the recycling unit 33 respectively in the first path 21b and the second path 22b. When a cooling operation is performed in this state, cold air circulates through the dehumidifying unit 38 and the recycling unit 33 in order.

When the dehumidifying unit 38 is saturated, the dehumidifying performance is deteriorated. Here, the user may exchange the dehumidifying unit 38 and the recycling unit 33 so that the saturated dehumidifying unit 38 now functions as a recycling unit. The user may replace the saturated dehumidifying unit 38 with a new unit.

The first path 21b is equipped with a temperature sensor 61 and a first humidity sensor 62. The temperature sensor 61 is disposed near an inlet 21a formed at the cover 71. The first humidity sensor 62 is disposed behind the dehumidifying unit 38. Humidity detected by the first humidity sensor 62 is used to determine the time to replace the dehumidifying unit 38.

Reference numeral 7 refers to a defrosting water discharge pipe.

FIG. 1B is a control block diagram of FIG. 1A. FIG. 1C is a flowchart illustrating a controlling method of the refrigerator according to the embodiment of the present invention.

Upon power application, the refrigerator performs an initializing operation (operation 111). A control unit 100 is input with a user's command through an input unit 101.

After the initializing operation, the temperature sensor 61 senses an inner temperature T1 of the refrigerator (operation 112). When the inner temperature T1 is greater than a preset temperature P, the control unit 100 starts a cooling operation by operating a compressor 14 and the freezing chamber ventilation fan 6 (operations 113 and 114).

The cold air in the freezing chamber 2 is introduced through the inlet 21a, and dehumidified while passing through the dehumidifying unit 38. The dehumidified cold air is sent to the evaporator 5. The cold air generated in the evaporator 5 is replenished with moisture while passing through the recycling unit 33. Next, the cold air is sent into the freezing chamber 3 through an outlet 22a connected with the second path 22b.

Thus, since the cold air in the freezing chamber 2 is introduced into the evaporator 5 after being dehumidified at the dehumidifying unit 38, frost at the evaporator 5 can be prevented.

During the cooling operation, the first humidity sensor 62 senses humidity of the cold air passed through the dehumidifying unit 38 (operation 115). Data of the sensed humidity H1 is supplied to the control unit 100. A micom 100a determines the dehumidifying unit 38 to be in a saturated state if the sensed humidity H1 is greater than a reference humidity R, and therefore displays a replacement time of the dehumidifying unit 38 through a display unit 102 (operations 116 and 117). Accordingly, the user replaces the dehumidifying unit 38 by exchanging the dehumidifying unit 38 with the recycling unit 33. Therefore, the dehumidifying unit 38 now mounted to the second path 22b performs the recycling function whereas the recycling unit 33 now mounted to the first path 21b dehumidifies the cold air entering the evaporator 5.

It is determined whether a stop command for stopping the cooling operation is input. When the stop command is not input, the micom 100a returns to operation 112 and repeats the above processes. When the stop command is input, the micom 100a stops the compressor 14 and the freezing chamber ventilation fan 6 (operations 118 and 119).

The control unit 100 according to this embodiment further includes a timer 100b accumulating the operation time of the refrigerator 1. The replacement time of the dehumidifying unit 38 may be determined based on the operation time accumulated in the timer 100b.

Referring to FIG. 1D, when the cooling operation is performed with the compressor 14 and the freezing chamber ventilation fan 6, the timer 100b accumulates the operation time B1 (operations 221 and 222). When the accumulated operation time B1 is not greater than a reference time Q, the micom 100a continues the cooling operation. When the operation time B1 is greater than the reference time Q, the dehumidifying unit 38 is determined to be in the saturated state. In this case, the micom 100a displays the replacement time through the display unit (operations 223 and 224). The user exchanges the dehumidifying unit 38 and the recycling unit 33 with each other, or replaces the saturated dehumidifying unit 38 with a new unit.

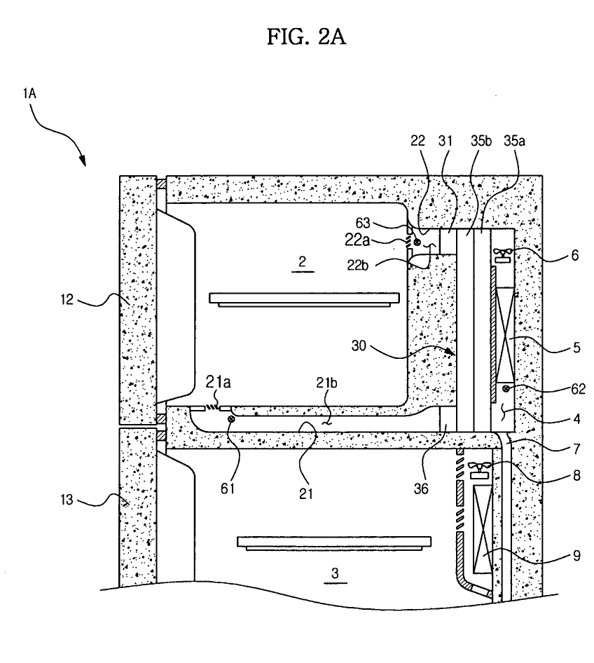

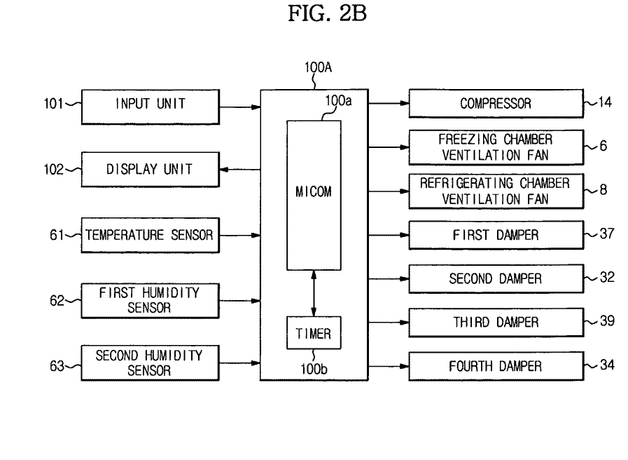

FIG. 2A is a sectional view of a refrigerator according to another embodiment of the present invention. FIG. 2B is a control block diagram of the refrigerator of FIG. 2A.

As shown in the drawings, structural elements of the refrigerator 1A according to another embodiment will be cited and explained by the same reference numerals as in the refrigerator 1 of the previous embodiment. In the same manner as described above with the previous embodiment, when a cooling operation is performed with the compressor 14 and the freezing chamber ventilation fan 6, the cold air in the freezing chamber 2 circulates by passing through the first path 21b, the evaporator 5, and the second path 22b and returning to the freezing chamber 2. Here, a second humidity sensor 63 that senses humidity of the freezing chamber 2 is provided to the second path 22b.

The refrigerator 1A selectively performs the dehumidifying function and the recycling function using first and second dampers 32 and 37 and, to this end, has a function conversion device for conversion between the dehumidifying function and the recycling function. Such a function conversion device can be implemented by a path conversion unit 30 that will be explained below.

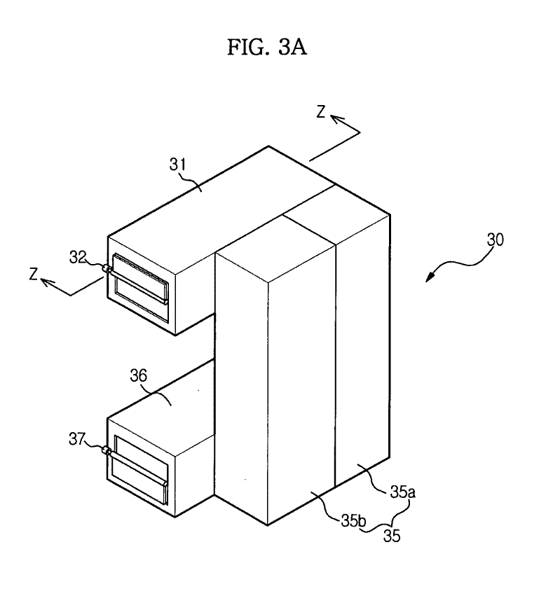

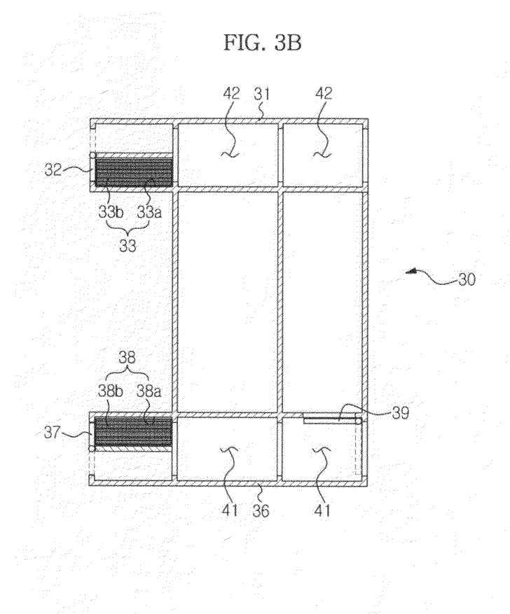

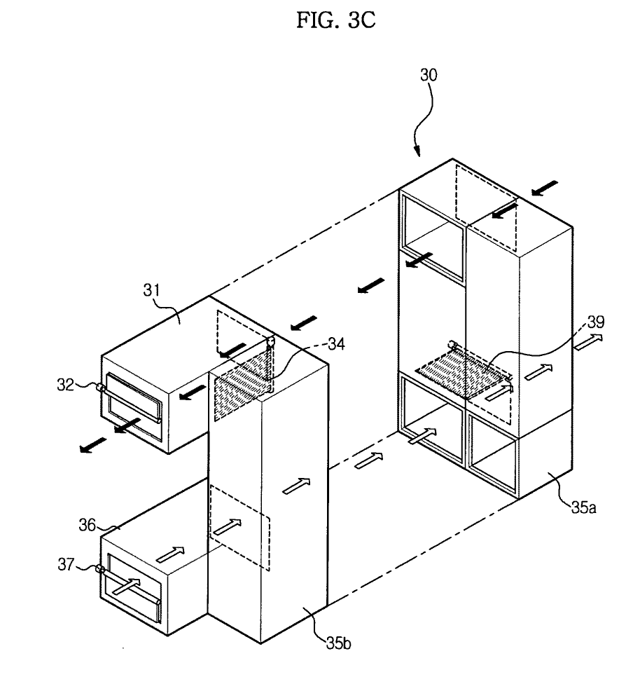

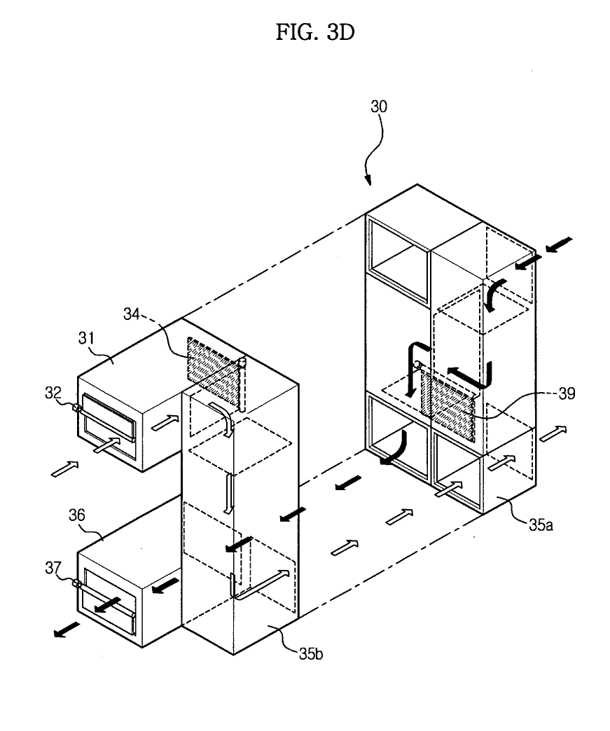

Referring to FIGS. 3A and 3B, the path conversion unit 30 includes an upper main duct 31 and a lower main duct 36, and a bypass duct 35.

The main ducts 31 and 36 supply main paths 41 and 42, respectively. The bypass duct 35 is constituted by a pair of bypass ducts 35a and 35b adjoining each other.

The dehumidifying unit 38 is charged with a moisture absorbent 38b and equipped with a case 38a including a plurality of vent holes. The case 38a is mounted in the lower main duct 36. In addition, the recycling unit 33 includes a case 33a charged with an absorbent 33b and formed with a plurality of via holes. The case 33a is mounted in the upper main duct 31.

The first damper 37 is mounted at one side of the lower main duct 36 and the second damper 32 is mounted at one side of the upper main duct 31. The first and the second dampers 32 and 37 are opened and closed by a control unit 100A, thereby selecting the dehumidifying function and the recycling function.

In FIG. 3C, both of the first and second dampers 37 and 32 are opened. In this state, both of the recycling unit 33 and the dehumidifying unit 38 can function and the operation mode is a humidifying mode. If the first damper 37 is opened with the second damper 32 closed, it is a dehumidifying mode. If both of the first and second dampers 37 and 32 are closed, it is a bypass mode.

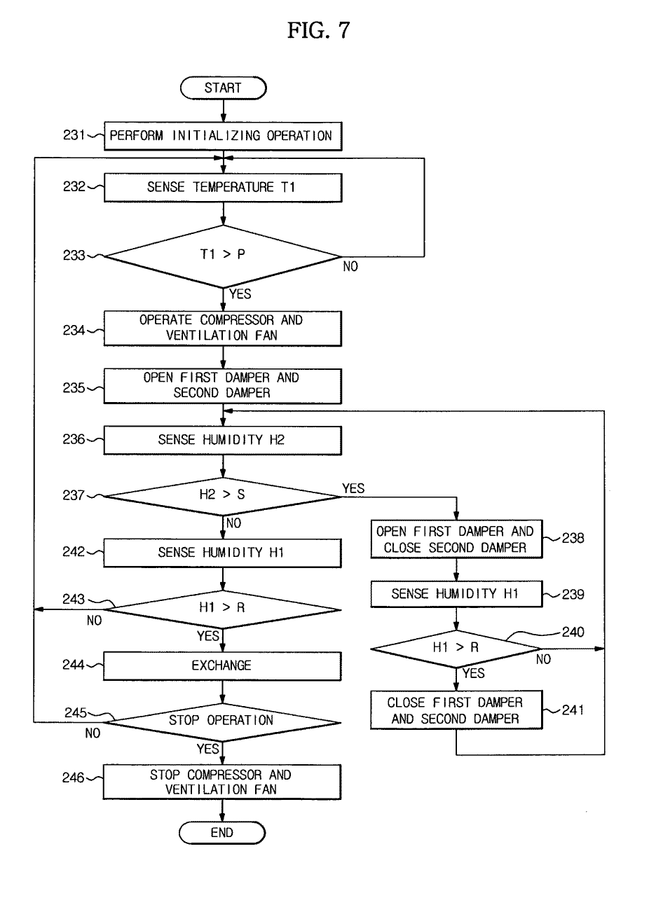

The control unit 100A selectively performs the humidifying mode, the dehumidifying mode and the bypass mode in accordance with humidity in the freezing chamber sensed by the second humidity sensor 63, to thereby prevent frosting at the evaporator 5. This will be explained in greater detail with respect to FIG. 7.

The path conversion unit 30 according to this embodiment includes third and fourth dampers 39 and 34 mounted therein to redirect the path. The third and the fourth dampers 39 and 34 are opened and closed under the control of the control unit 100A. FIG. 3C shows an example where the third and the fourth dampers 39 and 34 are both opened.

The control unit 100A determines whether the dehumidifying unit 38 is saturated, based on humidity sensed by the first humidity sensor 62. When the dehumidifying unit 38 is saturated, the dehumidifying unit 38 and the recycling unit 33 exchange their functions. That is, as shown in FIG. 3D, the control unit 100A closes both the third and the fourth dampers 39 and 34.

Referring to FIG. 3D, when a connection path is opened through the bypass ducts 35a and 35b according to the operations of the third and the fourth dampers 39 and 34, the cold air in the freezing chamber 2 is passed through the upper main duct 31, the bypass duct 35b, the bypass duct 35a in order and finally sent to the evaporator 5. While passing through the recycling unit 33, the cold air is dehumidified. At the same time, the cold air generated from the evaporator 5 is passed through the bypass duct 35a and the lower main duct 36, and finally sent to the freezing chamber 2 through the first air duct 21. The cold air generated from the evaporator 5 is humidified as passing through the saturated dehumidifying unit 38 and then is sent to the freezing chamber 2.

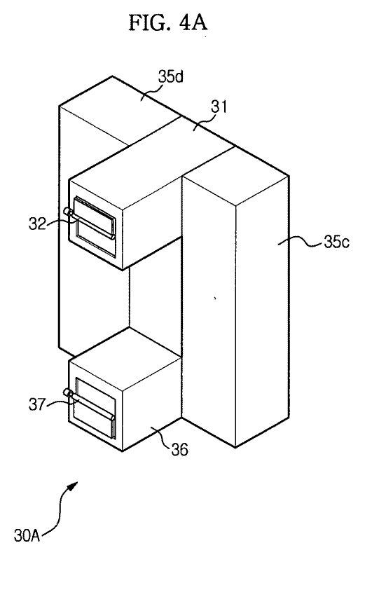

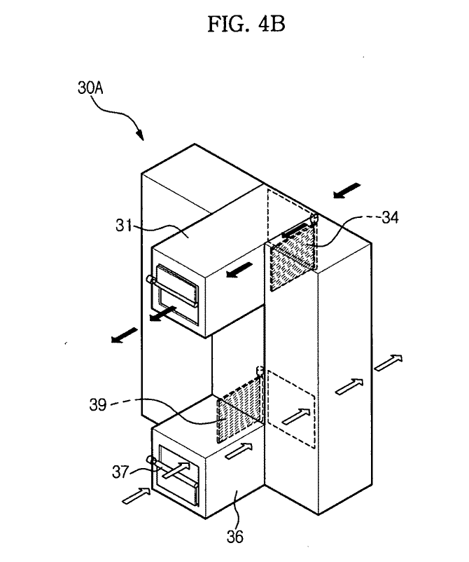

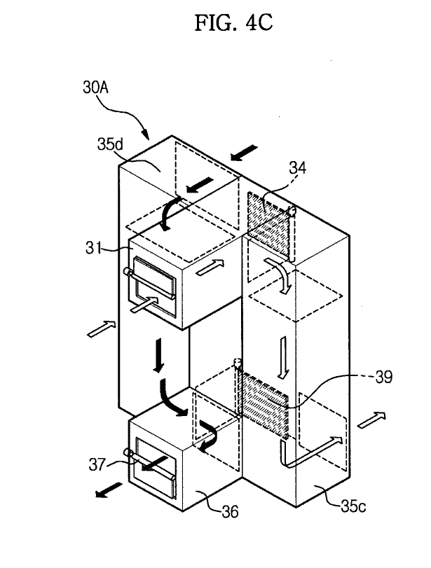

The size and shape of the path conversion unit 30 may be varied, for example, as shown in FIG. 4A. In FIG. 4A, the first through the fourth dampers 32, 34, 37 and 39 are configured in the same manner. Also, as explained above, the humidifying mode, the dehumidifying mode and the bypass mode can be selectively set according to the states of the first and the second dampers 37 and 32.

As shown in FIG. 4A, in a path conversion unit 30A according to a modified version, bypass ducts 35c and 35d are disposed on both sides of the main ducts 31 and 36.

Referring to FIG. 4B, when the first and the second dampers 37 and 32 are all opened, and also the third and the fourth dampers 39 and 34 are all opened, the dehumidifying unit 38 performs the dehumidifying function and the recycling unit 33 performs the recycling function. That is, the path conversion unit 30A operates in the humidifying mode.

A saturated state of the dehumidifying unit 38 is detected during the cooling operation. If the dehumidifying unit 38 is saturated, the dehumidifying unit 38 and the recycling unit 33 exchange their functions. That is, the control unit 100A closes both the third and the fourth dampers 39 and 34 and therefore the path is converted so that the dehumidifying unit 38 performs the recycling function and the recycling unit 33 performs the dehumidifying function.

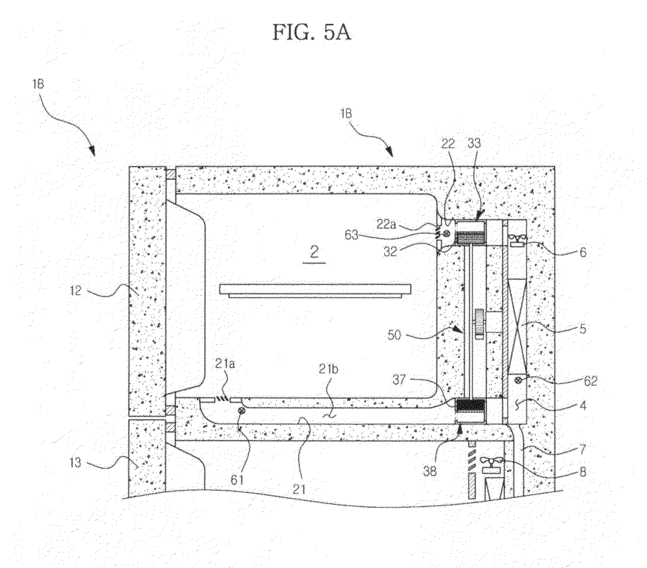

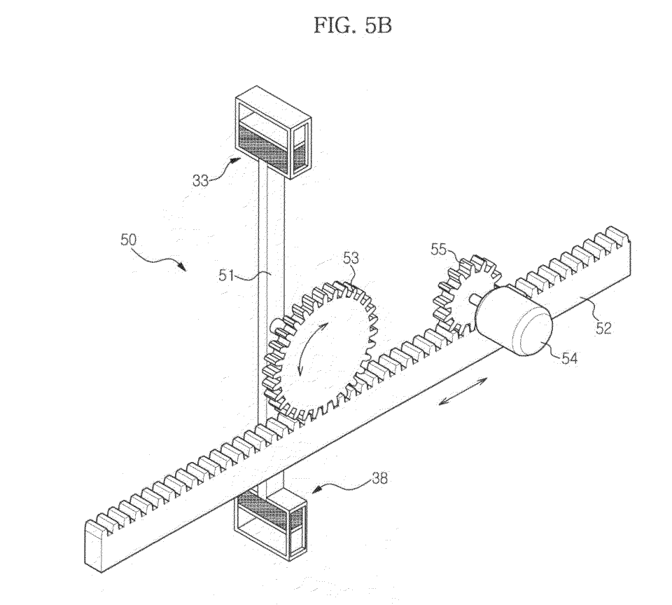

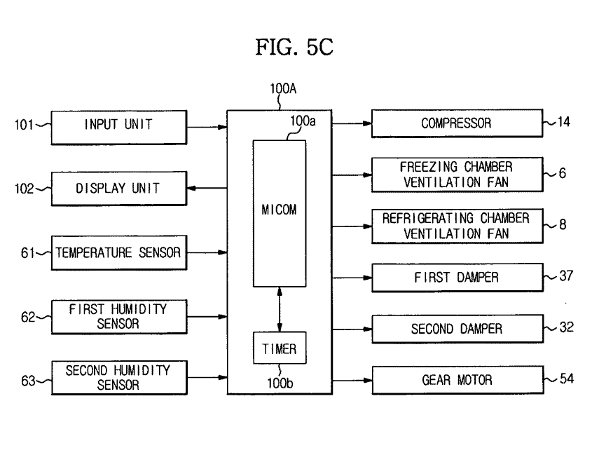

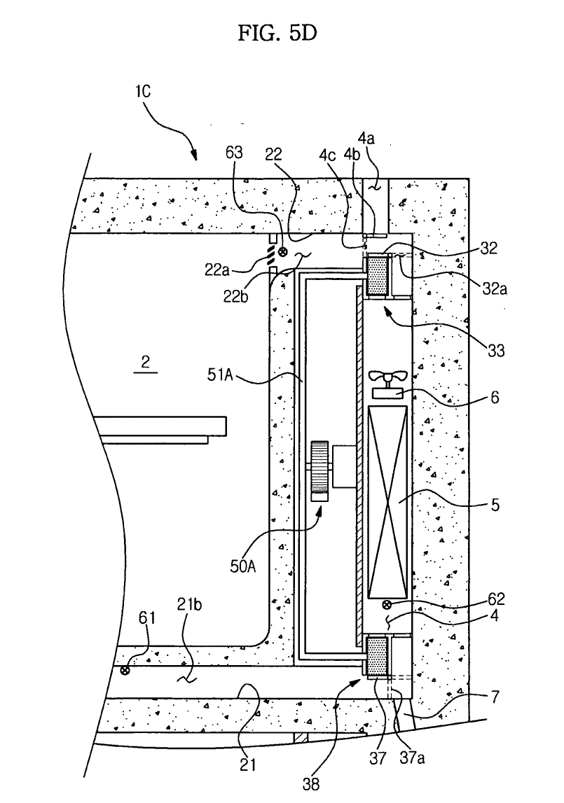

FIG. 5A is a sectional view of a refrigerator according to still another embodiment of the present invention. FIG. 5B is a perspective view of a rotation unit of the refrigerator of FIG. 5A. FIG. 5C is a control block diagram of the refrigerator of FIG. 5A.

A refrigerator 1B according to still another embodiment of the present invention will be explained using the same reference numerals as in the previous embodiments with regard to the same structural elements. Also, in the same manner as aforementioned, when a cooling operation is performed with the compressor 14 and the freezing chamber ventilation fan 6, the cold air in the freezing chamber 2 circulates by passing through the first path 21b, the evaporator 5, and the second path 22b and returning to the freezing chamber 2.

The refrigerator 1B can select the operation mode among the humidifying mode, the dehumidifying mode and the bypass mode by controlling the first and the second dampers 32 and 37.

The refrigerator 1B is equipped with a function conversion device for conversion between the dehumidifying function and the recycling function. Such a function conversion device may be implemented by a rotation unit 50 that changes positions of the dehumidifying unit 38 and the recycling unit 33.

The rotation unit 50 will be described in detail with reference to FIG. 5B.

The rotation unit 50 includes a rotational bar 51 fixed to the dehumidifying unit 38 and the recycling unit 33 with both ends, respectively, a rotational gear 53 integrally formed with the rotational bar 51, a gear motor 54 operated forward and backward to rotate the rotational bar 51, a circular gear 55 integrally mounted to a shaft of the gear motor 54, and a rack 52 meshed with the rotational gear 53 and the circular gear 55.

In the same manner as described above, the control unit 100A determines a saturated state of the dehumidifying unit 38 based on the humidity sensed by the first humidity sensor 62 or the operation time accumulated by the timer 100b. In this embodiment, however, when the dehumidifying unit 38 is in the saturated state, the control unit 100A operates the rotation unit 50. More specifically, when the control unit 100A applies a controlling command to the gear motor 54, the gear motor 54 is operated. The circular gear 55 is accordingly rotated. Corresponding to the rotational direction of the circular gear 55, the rack 52 is moved forward or backward.

When the rotational bar 51 connected with the rotational gear 53 is rotated forward, the dehumidifying unit 38 and the recycling unit 33 are operated simultaneously. The dehumidifying unit 38 is separated from the lower main duct 36 and received in the upper main duct 31, and the recycling unit 33 is separated from the upper main duct 31 and received in the lower main duct 36. As exchanging the positions, the dehumidifying unit 38 and the recycling unit 33 accordingly exchange the functions with each other.

As the rotational bar 52 is rotated backward, the dehumidifying unit 38 is received in the lower main duct 36 whereas the recycling unit 33 is received in the upper main duct 31. In this state, the dehumidifying unit 38 and the recycling unit 33 perform their original functions.

FIG. 5D is a sectional view showing the structure of a refrigerator according to a still further embodiment of the present invention. The refrigerator 1C according to the still further embodiment of the present invention will be explained using the same reference numerals as in the previous embodiment refrigerator 1B with regard to the same structural elements. Also, in the same manner as aforementioned, when a cooling operation is performed with the compressor 14 and the freezing chamber ventilation fan 6, the cold air in the freezing chamber 2 circulates by passing through the first path 21b, the evaporator 5, and the second path 22b and returning to the freezing chamber 2.

In the same manner as described above, the refrigerator 1C determines a saturated state of the dehumidifying unit 38 based on the humidity during the cooling operation or the accumulated operation time.

Additionally, the refrigerator 1C includes a rotation unit 50A to exchange positions of the dehumidifying unit 38 and the recycling unit 33. The rotation unit 50A has substantially the same structure as the rotation unit 50 shown in FIG. 5B except the rotational bar 51A having a modified form. The rotation bar 51A of this embodiment is bent at both ends thereof.

In addition, the refrigerator 1C includes a moisture outlet 4a formed at the receiving chamber 4 receiving the evaporator 5 fluidly communicated with the external air. A discharging damper 4b is mounted at the moisture outlet 4a to control the cold air according to the data being represented by two types including ‘1’ and ‘0’. The discharging damper 4b closes the moisture outlet 4a at a usual time, and converts to an opening position 4c to block the path connected to the second air duct 22 in a moisture discharging mode wherein the moisture is discharged to the outside.

As described above with the previous embodiments, the refrigerator 1C is capable of selecting the humidifying mode, the dehumidifying mode or the bypass mode by controlling the first and the second dampers 32 and 37 in a state where the moisture outlet 4a is closed by the discharging damper 4b.

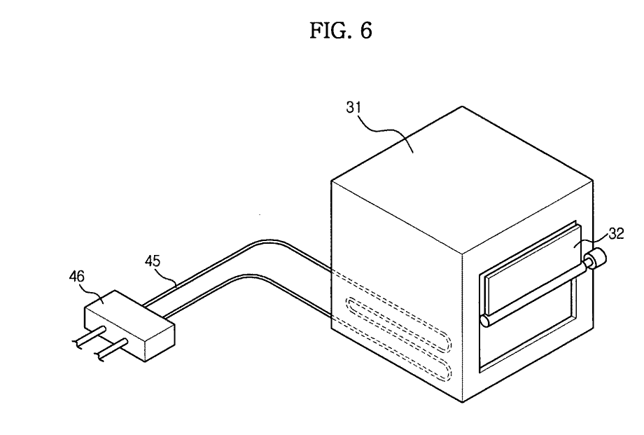

Furthermore, the recycling function can be enhanced by using a waste heat generated from the refrigerator. As shown in FIG. 6, if a valve 46 of a gas supply pipe 45 is mounted around the upper main duct 31 to supply hot gas, in a state where the recycling unit 33 is disposed in the upper main duct 31, the hot gas can be supplied through the gas supply pipe 45. According to this, the recycling operation to supply moisture can be performed more actively by the recycling unit 33.

FIG. 7 is a flowchart illustrating a controlling method for the refrigerator according to still another embodiment of the present invention, that is, the refrigerator having the function conversion device.

Upon power application, the refrigerator starts the initializing operation (operation 231).

The control unit 100A is input with the user's command through the input unit 101.

After the initializing operation, the temperature sensor 61 senses the inner temperature T1 (operation 232). When the inner temperature T1 is greater than the preset temperature P, the control unit 100A operates the compressor 14 and the freezing chamber ventilation fan 6 and opens the first and the second dampers 37 and 32, thereby performing the cooling operation (operations 233, 234 and 235). Accordingly, the cold air in the freezing chamber 2 is introduced through the inlet 21a, and dehumidified as it passes through the dehumidifying unit 38. The dehumidified cold air is sent to the evaporator 5. The cold air generated in the evaporator 5 is humidified as it passes through the recycling unit 33. Next, the cold air is sent into the freezing chamber 2 through the outlet 22a connected to the second path 21b.

During the cooling operation, the second humidity sensor 63 senses humidity H2 in the freezing chamber 2 and supplies the corresponding data to the control unit 100A (operation 236). When the humidity H2 in the freezing chamber 2 is greater than a reference inner humidity S, the control unit 100A opens the first damper to reduce the humidity H2 while closing the second damper (operations 237 and 238). Here, the cold air is dehumidified passing through only the dehumidifying unit 38 but not the recycling unit 33. In the dehumidifying mode, the first humidity sensor 62 senses the humidity H1 of the cold air passing through the dehumidifying unit 38. The control unit 100A determines whether the sensed humidity H1 is greater than the reference humidity R (operations 239 and 240).

When the sensed humidity H1 is not greater than the reference humidity R, that is, when the dehumidifying unit 38 is not in the saturated state, operation 236 is performed. As a result of operation 240, if the dehumidifying unit 38 is saturated, that is, if the dehumidifying function is hard to be effectively performed, the first and the second dampers 37 and 32 are both closed and the dehumidifying operation is performed relying on the evaporator 5 (operation 241).

As a result of operation 237, if the humidity H2 in the freezing chamber 2 is not greater than the reference inner humidity S, it is determined whether the humidity H1 sensed by the first humidity sensor 62 is greater than the reference humidity R (operations 242 and 243).

As a result of operation 243, if the sensed humidity H1 is not greater than the reference humidity R, operation 232 is performed.

As a result of operation 243, if the sensed humidity H1 is greater than the reference humidity R, it is determined that the dehumidifying unit 38 is saturated. Therefore, the control unit 100A operates the path conversion unit 30 or 30A or the rotation unit 50 or 50A, thereby exchanging the functions of the dehumidifying unit 38 and the recycling unit 33 (operation 244). Accordingly, the dehumidifying unit 38 performs the recycling function whereas the recycling unit 33 performs the dehumidifying function.

Next, it is determined whether the stop command for stopping the cooling operation is input. When the stop command is not input, the above processes are repeated from operation 232. When the stop command is input, the micom 100a stops the operation of the compressor 14 and the freezing chamber ventilation fan 6 (operations 245 and 246).

The control unit 100A according to this embodiment includes a timer 100b accumulating the operation time of the refrigerator, and determines the saturated state of the dehumidifying unit 38 depending on the accumulated time.

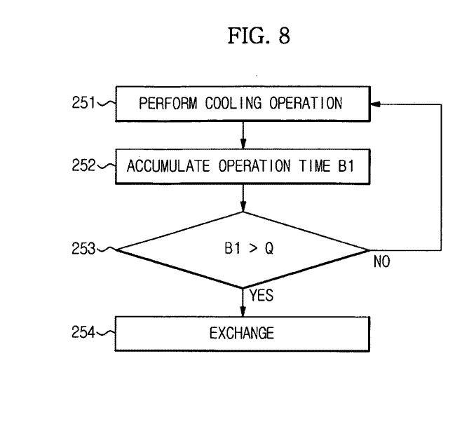

Referring to FIG. 8, when the cooling operation is performed using the compressor 14 and the freezing chamber ventilation fan 6, the timer 100b accumulates the operation time B1 (operations 251 and 252). When the accumulated operation time B1 is not greater than the reference time Q, the micom 100a continues the cooling operation. When the operation time B1 is greater than the reference time Q, the dehumidifying unit 38 is determined to be saturated. In this case, the control unit 100A operates the path conversion unit 30 or 30A or the rotation unit 50 or 50A such that the functions of the dehumidifying unit 38 and the recycling unit 33 are exchanged (operations 253 and 254).

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A refrigerator comprising:
a storage chamber to contain cold air;
an evaporator mounted on a circulation path of the cold air; and
a dehumidifying unit and a recycling unit removably mounted on first and second sides of the circulation path, the evaporator being disposed between the dehumidifying unit and the recycling unit.

2. The refrigerator according to claim 1, further comprising:
a humidity sensor sensing a humidity of the cold air as the cold air passes through the dehumidifying unit; and
a control unit determining a time to replace the dehumidifying unit according to the sensed humidity.

3. The refrigerator according to claim 1, further comprising a control unit determining a time to replace the dehumidifying unit according to an accumulated operation time of the refrigerator, the operation time being accumulated in the timer.

4. The refrigerator according to claim 2, further comprising a display unit displaying a replacement time of the dehumidifying unit.

5. A refrigerator comprising:
a storage chamber to contain cold air;
an evaporator mounted on a circulation path of the cold air;
a dehumidifying unit and a recycling unit removably mounted on first and second sides of the circulation path, the evaporator being disposed between the dehumidifying unit and the recycling unit;
a function conversion device exchanging functions of the dehumidifying unit and the recycling unit; and
a control unit replacing the dehumidifying unit using the function conversion device when the dehumidifying unit is in a saturated state.

6. The refrigerator according to claim 5, further comprising a humidity sensor sensing a humidity of the cold air circulating in the storage chamber or the circulation path.

7. The refrigerator according to claim 5, further comprising a timer accumulating the operation time of the refrigerator.

8. The refrigerator according to claim 6, wherein the control unit determines a saturated state of the dehumidifying unit according to one of the sensed humidity or the accumulated operation time.

9. The refrigerator according to claim 5, further comprising a plurality of dampers mounted at one side of the dehumidifying unit and the recycling unit, respectively, to selectively pass the cold air of the storage chamber.

10. The refrigerator according to claim 5, wherein the function conversion device includes a path conversion unit varying a path interconnecting the dehumidifying unit and the recycling unit.

11. The refrigerator according to claim 10, wherein the path conversion unit varies between:
a main path connecting the dehumidifying unit and the recycling unit;
a bypass path bypassing the main path; and
a plurality of dampers to form any one of the main path and the bypass path.

12. The refrigerator according to claim 5, wherein the function conversion device includes a rotation unit to exchange positions of the dehumidifying unit and the recycling unit.

13. The refrigerator according to claim 12, wherein the rotation unit comprises:
a dehumidifying unit;
a rotational bar connected with the recycling unit at both sides thereof;
a gear motor rotating the rotational bar;
a circular gear connected with the gear motor;
a rotational gear integrally formed with the rotational bar; and
a rack meshed with the circular gear and the rotational gear.

14. The refrigerator according to claim 5, further comprising:
a gas supply pipe provided around the dehumidifying unit or the recycling unit to supply hot gas; and
a valve mounted to the gas supply pipe to control supply of the hot gas.

15. The refrigerator according to claim 5, further comprising:
a receiving chamber receiving the evaporator;
a moisture outlet formed at the receiving chamber in fluid communication with external air; and
a damper selectively opening and closing the moisture outlet.

16. A controlling method of a refrigerator, comprising:
performing a cooling operation comprising passing cold air in a storage chamber through a dehumidifying unit and a recycling unit which are mounted on a connecting path;
determining a saturated state of the dehumidifying unit during the cooling operation; and
displaying a time to replace the dehumidifying unit when the dehumidifying unit is determined to be in the saturated state.

17. The controlling method according to claim 16, wherein the determining the saturated state comprises determining according to humidity of the cold air passed through the dehumidifying unit.

18. The controlling method according to claim 16, wherein the determining the saturated state comprises determining according to an accumulated operation time of the refrigerator.

19. A controlling method of a refrigerator, comprising:
performing a cooling operation comprising passing cold air in a storage chamber through a dehumidifying unit and a recycling unit which are mounted on a connecting path;
determining a humidity in the storage chamber during the cooling operation; and
passing the cold air selectively through the dehumidifying unit or the recycling unit according to the determined humidity in the storage chamber.

20. The controlling method according to claim 19, wherein, when the humidity in the storage chamber is greater than a predetermined reference humidity, the method further comprises passing the cold air of the storage chamber only through the dehumidifying unit.

21. The controlling method according to claim 19, wherein, when the humidity in the storage chamber is greater than the reference humidity and the dehumidifying unit is in a saturated state, the method further comprises passing the cold air past the dehumidifying and the recycling unit.

22. The controlling method according to claim 19, wherein, when the humidity in the storage chamber is not greater than the reference humidity and the dehumidifying unit is in a saturated state the method further comprises exchanging the functions of the dehumidifying unit and the recycling unit.

23. The controlling method according to claim 21, further comprising determining the saturated state of the dehumidifying unit according to the humidity of the cold air of the storage chamber, passing through the dehumidifying unit.

24. The controlling method according to claim 21, further comprising determining the saturated state of the dehumidifying unit according to an accumulated operation time of the refrigerator.
